(19) United States
(12) Patent Application Publication
(10) Pub. No.: US 2025/0304045 A1
(43) Pub. Date: Oct. 2, 2025

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventor: Yoshihiro Oniwa, Tokyo (JP)

(21) Appl. No.: 19/062,269

(22) Filed: Feb. 25, 2025

(30) Foreign Application Priority Data
Mar. 28, 2024 (JP) 2024-053515

(51) Int. Cl. B60W 30/09; B60W 10/20; B60W 50/14

(52) U.S. Cl. CPC B60W 30/09; B60W 10/20; B60W 50/14; B60W 2552/53; B60W 2710/20; B60W 2720/106

(57) ABSTRACT

A vehicle control device includes a recognizer configured to recognize a surrounding situation of a host vehicle and a controller configured to control one or both of steering and acceleration/deceleration of the host vehicle when an obstacle is present in front of the host vehicle on the basis of a recognition result from the recognizer. The controller performs at least steering control for moving the host vehicle to the center of a traveling lane when it is determined that an obstacle is present in front of the host vehicle. The controller stops the steering control when a degree of recognition of marking lines defining the traveling lane of the host vehicle by the recognizer is less than a threshold value at the time of performing of the steering control.

### CROSS-REFERENCE TO RELATED APPLICATION

Priority is claimed on Japanese Patent Application No. 2024-053515, filed Mar. 28, 2024, the content of which is incorporated herein by reference.

### BACKGROUND

### Field of the Invention

The present invention relates to a vehicle control device, a vehicle control method, and a storage medium.

### Description of Related Art

Recently, countermeasures for providing access to a sustainable transportation system in which vulnerable persons out of traffic participants are considered have been actively studied. In order to realize such countermeasures, focus has been concentrated on research and development for further improving safety or convenience of traffic through research and development on preventive safety technology. In this regard, a technique of estimating whether a following vehicle and an obstacle will collide when a host vehicle is caused to avoid the obstacle through one avoidance operation of lane change and steering and determining an avoidance operation on the basis of the estimation result for collision has been recently disclosed (for example, see Japanese

Unexamined Patent Application, First Publication No. 2019-151185).

### SUMMARY

In such preventive safety technology, vehicle behavior for attracting the attention of an occupant of a vehicle to the surroundings being performed before control for avoidance of collision between the vehicle and an obstacle is performed has not been considered, and what vehicle behavior to perform according to the surrounding situation has not been studied. Accordingly, there is a problem in that appropriate vehicle control based on the surrounding situation of the vehicle may not be performed in the related art.

In order to solve the aforementioned problem, an objective of the present invention is to provide a vehicle control device, a vehicle control method, and a storage medium that can perform more appropriate vehicle control according to a surrounding situation of a vehicle before control for avoidance of collision between the vehicle and an obstacle is performed. Another objective thereof is to contribute to advancement of a sustainable transportation system.

A vehicle control device, a vehicle control method, and a storage medium according to the present invention employ the following configurations.
(1) According to an aspect of the present invention, there is provided a vehicle control device including: a recognizer configured to recognize a surrounding situation of a host vehicle; and a controller configured to control one or both of steering and acceleration/deceleration of the host vehicle when an obstacle is present in front of the host vehicle on the basis of a recognition result from the recognizer, wherein the controller performs at least steering control for moving the host vehicle to the center of a traveling lane when it is determined that an obstacle is present in front of the host vehicle, and the controller stops the steering control when a degree of recognition of marking lines defining the traveling lane of the host vehicle by the recognizer is less than a threshold value at the time of performing of the steering control.
(2) In the aspect of (1), the controller causes the host vehicle to travel along the marking line closer to the host vehicle when a degree of recognition of the marking line closer to the host vehicle out of two marking lines defining the traveling lane is equal to or greater than a threshold value and a degree of recognition of the marking line farther from the host vehicle is less than the threshold value.
(3) In the aspect of (1), the controller performs deceleration control for decelerating the host vehicle when an obstacle is present in front of the host vehicle, and the controller continues to perform the deceleration control when the degree of recognition of the marking lines defining the traveling lane of the host vehicle by the recognizer is less than the threshold value at the time of performing of the deceleration control.
(4) The vehicle control device according to the aspect of (3) may further include a notification controller configured to notify that at least one control of the steering control and the deceleration control has ended when the control has been ended by the controller, and the notification controller does not notify that the steering control has ended when the degree of recognition of the marking lines defining the traveling lane of the host vehicle by the recognizer becomes less than the threshold value at the time of performing the steering control and thus the steering control stops but the deceleration control continues to be performed.
(5) In the aspect of (1) the controller stops the steering control when a state in which the degree of recognition is less than the threshold value is maintained for a predetermined time or more.
(6) According to another aspect of the present invention, there is provided a vehicle control method that is performed by a computer, the vehicle control method including: recognizing a surrounding situation of a host vehicle; and performing driving control for controlling one or both of steering and acceleration/deceleration of the host vehicle when an obstacle is present in front of the host vehicle on the basis of a recognition result, wherein the driving control includes performing at least steering control for moving the host vehicle to the center of a traveling lane when it is determined that an obstacle is present in front of the host vehicle, and the driving control includes stopping the steering control when a degree of recognition of marking lines defining the traveling lane of the host vehicle by the recognizer is less than a threshold value at the time of performing of the steering control.
(7) According to another aspect of the present invention, there is provided a non-transitory computer-readable storage medium storing a program, the program causing a computer to perform: recognizing a surrounding situation of a host vehicle; and performing driving control for controlling one or both of steering and acceleration/deceleration of the host vehicle when an obstacle is present in front of the host vehicle on the basis of a recognition result, wherein the driving control includes performing at least steering control for moving the host vehicle to the center of a traveling lane when it is determined that an obstacle is present in front of the host vehicle, and the driving control includes stopping the steering control when a degree of recognition of marking lines defining the traveling lane of the host vehicle by the recognizer is less than a threshold value at the time of performing of the steering control.

According to the aspects of (1) to (7), it is possible to perform more appropriate vehicle control according to a surrounding situation of a vehicle before control for avoidance of collision between the vehicle and an obstacle is performed.

### BRIEF DESCRIPTION OF THE DRAWINGS

FIG. 1 is a diagram illustrating a configuration of a host vehicle in which a vehicle control device according to an embodiment is mounted.

FIG. 2 is a diagram illustrating details of vehicle control associated with collision avoidance.

FIG. 3 is a diagram illustrating details of attention attraction control.

FIG. 4 is a diagram illustrating details of collision alarm control.

FIG. 5 is a diagram illustrating details of automatic steering avoidance control.

FIG. 6 is a diagram illustrating steering control with a driver steering trigger.

FIG. 7 is a diagram illustrating a first example of centering steering control.

FIG. 8 is a diagram illustrating a second example of centering steering control.

FIG. 9 is a diagram illustrating a third example of centering steering control.

FIG. 10 is a diagram illustrating a fourth example of centering steering control.

FIG. 11 is a diagram illustrating a lane center error range and a lateral position error range.

FIG. 12 is a diagram illustrating a fifth example of centering steering control.

FIG. 13 is a diagram illustrating a sixth example of centering steering control.

FIG. 14 is a flowchart illustrating an example of a process flow that is performed by the driving support device according to the embodiment.

FIG. 15 is a flowchart illustrating an example of a centering steering control process.

### DESCRIPTION OF EMBODIMENTS

Hereinafter, a vehicle control device, a vehicle control method, and a storage medium according to an embodiment of the present invention will be described with reference to the accompanying drawings.

### Entire Configuration

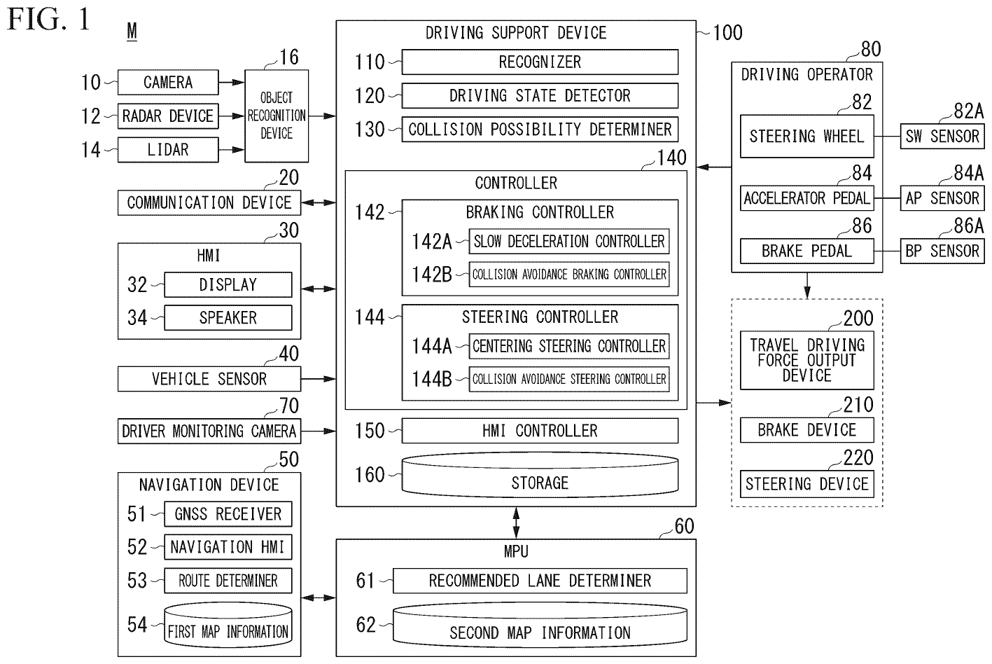

FIG. 1 is a diagram illustrating a configuration of a host vehicle M in which a vehicle control device according to an embodiment is mounted. The host vehicle M is, for example, a vehicle with two wheels, three wheels, or four wheels, and a drive source thereof is an internal combustion engine such as a diesel engine or a gasoline engine, an electric motor, or a combination thereof. The electric motor operates using electric power generated by a power generator connected to the internal combustion engine or using electric power discharged from a secondary battery or a fuel cell.

For example, a camera 10, a radar device 12, a Light Detection and Ranging (LIDAR) device 14, an object recognition device 16, a communication device 20, a human-machine interface (HMI) 30, a vehicle sensor 40, a navigation device 50, a map positioning unit (MPU) 60, a driver monitoring camera 70, a driving operator 80, a driving support device 100, a travel driving force output device 200, a brake device 210, and a steering device 220 are mounted in the host vehicle M. These devices or instruments are connected to each other via a multiplex communication line such as a controller area network (CAN) communication line, a serial communication line, a radio communication network, or the like. The configuration illustrated in FIG. 1 is only an example and a part of the configuration may be omitted or another configuration may be added thereto. The HMI 30 is an example of a “notifier.” The driving support device 100 is an example of a “vehicle control device.”

The camera 10 is, for example, a digital camera using a solid-state imaging device such as a charge coupled device (CCD) or a complementary metal oxide semiconductor (CMOS). The camera 10 is attached to an arbitrary position on the host vehicle M. When a forward view is imaged, the camera 10 is attached to an upper part of a front windshield, a rear surface of a rearview mirror, or the like. The camera 10 images the surroundings of the host vehicle M, for example, periodically and repeatedly. The camera 10 may be a stereo camera.

The radar device 12 radiates radio waves such as millimeter waves to the surroundings of the host vehicle M, detects radio waves (reflected waves) reflected by an object, and detects at least a position (a distance and a direction) of the object. The radar device 12 is attached to an arbitrary position on the host vehicle M. The radar device 12 may detect a position and a speed of an object using a frequency modulated continuous wave (FM-CW) method.

The LIDAR device 14 radiates light (or electromagnetic waves of wavelengths close to light) to the surroundings of the host vehicle M and measures scattered light. The LIDAR device 14 detects a distance to an object on the basis of a time from radiation of light to reception of light. The radiated light is, for example, a pulse-like laser beam. The LIDAR device 14 is attached to an arbitrary position on the host vehicle M.

The object recognition device 16 performs a sensor fusion process on results of detection from some or all of the camera 10, the radar device 12, and the LIDAR device 14 and recognizes a position, a type, a speed, and the like of an object. The object recognition device 16 outputs the result of recognition to the driving support device 100. The object recognition device 16 may output the results of detection from the camera 10, the radar device 12, the LIDAR device 14, and the object recognition device 16 to the driving support device 100 without any change. The object recognition device 16 may be omitted from the host vehicle M. Some or all of the camera 10, the radar device 12, and the LIDAR device 14 are an example of an “outside detection device.”

The communication device 20 communicates with other vehicles near the host vehicle M, for example, using a cellular network, a Wi-Fi network, Bluetooth (registered trademark), or dedicated short range communication (DSRC) or communicates with various server devices via radio base stations.

The HMI 30 presents various types of information to an occupant of the host vehicle M and receives an input operation from the occupant. The HMI 30 includes, for example, a display 32 and a speaker 34. The display 32 is, for example, a liquid crystal display (LCD) device or an organic electroluminescence (EL) display device. The display 32 displays various images (including a video) according to the embodiment. The display 32 may be configured as a touch panel which is a unified body with an input. The speaker 34 outputs predetermined sound (for example, an alarm). The HMI 30 may include a microphone, buzzers, a vibration generator (a vibrator), a touch panel, switches, and keys in addition to (or instead of) the display 32 and the speaker 34.

The vehicle sensor 40 includes a vehicle speed sensor that detects a speed of the host vehicle M, an acceleration sensor that detects acceleration, a yaw rate sensor that detects a yaw rate (an angular velocity around a vertical axis passing through the center of gravity of the host vehicle M), a direction sensor that detects a direction of the host vehicle M, and a steering angle sensor that detects a steering angle (which may be an angle of turning wheels or may be an operation angle of a steering wheel) of the host vehicle M. The vehicle sensor 40 may include a position sensor that detects a position of the host vehicle M. The position sensor is, for example, a sensor that acquires position information (longitude and latitude information) from a global positioning system (GPS) device. The position sensor may be a sensor that acquires position information using a global navigation satellite system (GNSS) receiver 51 of the navigation device 50.

The navigation device 50 includes, for example, a GNSS receiver 51, a navigation HMI 52, and a route determiner 53. The navigation device 50 stores first map information 54 in a storage device such as a hard disk drive (HDD) or a flash memory. The GNSS receiver 51 identifies a position of the host vehicle M on the basis of signals received from GNSS satellites. The position of the host vehicle M may be identified or corrected by an inertial navigation system (INS) using the output of the vehicle sensor 40. The navigation HMI 52 includes a display device, a speaker, a touch panel, and keys. The navigation HMI 52 may be partially or wholly shared by the HMI 30. For example, the route determiner 53 determines a route (hereinafter referred to as a route on a map) from the position of the host vehicle M identified by the GNSS receiver 51 (or an input arbitrary position) to a destination input by an occupant using the navigation HMI 52 with reference to the first map information 54. The first map information 54 is, for example, information in which a road shape is expressed by links indicating a road and nodes connected by the links. The first map information 54 may include a curvature of a road and point of interest (POI) information. The route on a map is output to the MPU 60. The navigation device 50 may perform route guidance using the navigation HMI 52 on the basis of the route on a map. The navigation device 50 may be realized, for example, by a function of a terminal device such as a smartphone or a tablet terminal which is carried by an occupant. The navigation device 50 may transmit a current position and a destination to a navigation server via the communication device 20 and acquire a route which is equivalent to the route on a map from the navigation server.

The MPU 60 includes, for example, a recommended lane determiner 61 and stores second map information 62 in a storage device such as an HDD or a flash memory.

The recommended lane determiner 61 divides the route on a map provided from the navigation device 50 into a plurality of blocks (for example, blocks every 100 [m] in a vehicle traveling direction) and determines a recommended lane for each block with reference to the second map information 62. The recommended lane determiner 61 determines in which lane from the leftmost the host vehicle M is to travel. When there is a branching point in the route on a map, the recommended lane determiner 61 determines the recommended lane such that the host vehicle M can travel along a rational route for traveling to a branching destination. The second map information 62 is map information with higher precision than the first map information 54. For example, the second map information 62 may include information of centers of lanes and information of boundaries of lanes such as road marking lines (hereinafter referred to as marking lines) defining a lane. The second map information 62 may include road information, traffic regulation information, address information (addresses and postal codes), facility information, and phone number information. The second map information 62 may be updated from time to time by causing the communication device 20 to communicate with another device. The first map information 54 and the second map information 62 may be stored in a storage unit of the driving support device 100.

The driver monitoring camera 70 is, for example, a digital camera using a solid-state imaging device such as a CCD or a CMOS. The driver monitoring camera 70 is attached to an arbitrary position on the host vehicle M in a place and a direction in which the head and the upper half (including positions of hands) of an occupant (a driver) sitting on a driver's seat of the host vehicle M can be imaged from the front (such that the face of the driver is imaged). For example, the driver monitoring camera 70 is attached to an upper part of a display device which is provided at the center of an instrument panel of the host vehicle M. The driver monitoring camera 70 outputs an image obtained by imaging a cabin including the driver of the host vehicle M from an installed position thereof to the driving support device 100.

The driving operator 80 includes, for example, a steering wheel 82, an accelerator pedal 84, a brake pedal 86, an operation switch of a direction indicator, a shift lever, and other operators. A sensor that detects an amount of operation or whether an operation has been performed is attached to the driving operator 80. Results of detection of the sensor are output to the driving support device 100 or output to some or all of the travel driving force output device 200, the brake device 210, and the steering device 220.

For example, a steering wheel sensor (SW sensor) 82A is provided in the steering wheel 82. The SW sensor 82A detects whether a driver grasps the steering wheel 82. The SW sensor 82A detects an amount of operation (an amount of steering torque, an amount of steering) of the steering wheel 82 by the driver. The steering wheel 82 does not have to have a ring shape and may have a shape of a deformed steering wheel, a joystick, a button, or the like. In this case, the SW sensor 82A detects an amount of operation corresponding to each shape.

An accelerator pedal sensor (AP sensor) 84A is attached to the accelerator pedal 84. The AP sensor 84A detects an amount of operation (an opening level) of the accelerator pedal 84 which varies according to the driver's operation on the accelerator pedal 84. A brake pedal sensor (BP sensor) 86A is provided in the brake pedal 86. The BP sensor 86A detects an amount of operation (an opening level) of the brake pedal 86 which varies according to the driver's operation on the brake pedal 86.

The travel driving force output device 200 outputs a travel driving force (a torque) for allowing the host vehicle M to travel to driving wheels. The travel driving force output device 200 includes, for example, a combination of an internal combustion engine, an electric motor, and a transmission and an electronic control unit (ECU) that controls them. The ECU controls the aforementioned constituents on the basis of information input from the driving support device 100 or information input from the operator 80.

The brake device 210 includes, for example, a brake caliper, a cylinder that transmits a hydraulic pressure to the brake caliper, an electric motor that generates a hydraulic pressure in the cylinder, and an ECU. The ECU controls the electric motor on the basis of the information input from the driving support device 100 or the information input from the operator 80 such that a brake torque based on a braking operation is output to vehicle wheels. The brake device 210 may include a mechanism for transmitting a hydraulic pressure generated by an operation of the brake pedal included in the driving operator 80 to the cylinder via a master cylinder as a backup. The brake device 210 is not limited to the above-mentioned configuration, and may be an electronically controlled hydraulic brake device that controls an actuator on the basis of information input from the driving support device 100 such that the hydraulic pressure of the master cylinder is transmitted to the cylinder.

The steering device 220 includes, for example, a steering ECU and an electric motor. The electric motor changes a direction of turning wheels, for example, by applying a force to a rack-and-pinion mechanism. The steering ECU drives the electric motor on the basis of the information input from the driving support device 100 or the information input from the operator 80 and changes the direction of the turning wheels.

### Driving Support Device

The driving support device 100 includes, for example, a recognizer 110, a driving state detector 120, a collision possibility determiner 130, a controller 140, an HMI controller 150, and a storage 160. The recognizer 110, the driving state detector 120, the collision possibility determiner 130, the controller 140, the HMI controller 150 are realized, for example, by causing a hardware processor such as a central processing unit (CPU) to execute a program (software). Some or all of these constituents may be realized by hardware (a circuit part including circuitry) such as a large scale integration (LSI) device, an application-specific integrated circuit (ASIC), or a field-programmable gate array (FPGA), a graphics processing unit (GPU), or a system on chip (SOC) or may be cooperatively realized by software and hardware. The program may be stored in a storage device (a storage device including a non-transitory storage medium) such as an HDD or a flash memory of the driving support device 100 in advance, or may be stored in a removable storage medium such as a DVD or a CD-ROM and installed in the HDD or the flash memory of the driving support device 100 by setting the removable storage medium (a non-transitory storage medium) into a drive device. The HMI controller 150 is an example of a “notification controller.”

For example, settings are set in the travel driving force output device 200, the brake device 210, and the steering device 220 such that instructions from the driving support device 100 to the travel driving force output device 200, the brake device 210, and the steering device 220 are performed more preferentially than the results of detection from the driving operator 80. Regarding braking, when a braking force based on an amount of operation of the brake pedal 86 is larger than an instruction from the driving support device 100, settings may be set such that braking using the braking force based on the amount of operation is preferentially performed. As a means for preferentially performing an instruction from the driving support device 100, communication priority in an on-board local area network (LAN) may be used.

The storage 160 may be realized by the aforementioned various storage devices, a solid-state drive (SSD), an electrically erasable programmable read only memory (EEPROM), a read only memory (ROM), a random access memory (RAM), or the like. For example, programs and various types of other information are stored in the storage 160. The aforementioned map information (the first map information 54 and the second map information 62) may be stored in the storage 160.

The recognizer 110 recognizes a surrounding situation of the host vehicle M on the basis of information input from an outside detection device. For example, the recognizer 110 recognizes states such as a position, a speed, and an acceleration of an object near the host vehicle M (for example, within a predetermined distance from the host vehicle M). Examples of the object include another vehicle a bicycle, and a pedestrian. For example, a position of an object is recognized as a position in an absolute coordinate system with a representative point (such as the center of gravity or the center of a drive shaft) of the host vehicle M and is used for control. A position of an object may be expressed as a representative point such as the center of gravity or a corner of the object or may be expressed as an area. A “state” of an object may include an acceleration or a jerk of the object or a “moving state” (for example, whether lane change is being performed or whether lane change is going to be performed) thereof. The recognizer 110 recognizes a position or a speed relative to an object.

The recognizer 110 recognizes, for example, a lane (a traveling lane) in which the host vehicle M is traveling. For example, the recognizer 110 performs a known analysis process (for example, edge extraction, feature extraction, or a pattern matching process) on an image (a camera image) captured by the camera 10 and recognizes a position or a pattern of a marking line (for example, arrangement of a solid line and a dotted line) near the host vehicle M from the analysis result. The recognizer 110 may recognize a position or a pattern of a marking line near the host vehicle M with reference to map information (the second map information 62) on the basis of the position information of the host vehicle M. The recognizer 110 may recognize the traveling lane using at least one of a position or a pattern of a marking line acquired from the camera image and a position or a pattern of a marking line acquired from the map information. The recognizer 110 is not limited to the marking lines, but may recognize the traveling lane by recognizing traveling lane boundaries (road boundaries) including edges of roadsides, curbstones, median strips, and guard rails. In this recognition, the position of the host vehicle M acquired from the navigation device 50 or the result of processing from the INS may be considered. The recognizer 110 may recognize a neighboring lane which is adjacent to the traveling lane. The recognizer 110 recognizes an obstacle, a stop line, a red signal, a toll gate, or other road events from recognition results of objects. The obstacle is an object which the host vehicle M needs to avoid collision with, and an example thereof is another vehicle.

The recognizer 110 may derive a degree of recognition of a marking line defining the traveling lane on the basis of the analysis result of a camera image. The degree of recognition of a marking line is an index value (a reliability of recognition) indicating a likelihood that a marking line is present (reliability of recognition), and the index value increases as the degree of recognition increases. For example, the recognizer 110 may compare a position or a pattern of a marking line acquired from a camera image with a position or a pattern of a marking line acquired from map information and derive a degree of recognition based on a magnitude of a degree of match (or a degree of separation). When a broken part or an unclear part due to scratch, loss, or the like is recognized in the marking line acquired from the camera image, the recognizer 110 may decrease the degree of recognition according to the magnitude of that part. The recognizer 110 may derive a degree of recognition for each marking line on the right and left sides defining the traveling lane or may average the degrees of recognition of the marking lines on the right and left sides. The recognizer 110 may derive a degree of recognition of a marking line defining a lane (for example, a neighboring lane) other than the traveling lane near the host vehicle M.

The recognizer 110 may recognize a position or a posture of the host vehicle M with respect to the traveling lane. The recognizer 110 may recognize, for example, a degree of separation of a reference point of the host vehicle M from the lane center and an angle of the traveling direction of the host vehicle M with respect to a line formed by connecting the lane centers as the position and the posture of the host vehicle M with respect to the traveling lane. Instead, the recognizer 110 may recognize a position of a reference point of the host vehicle M with respect to one side line of the traveling lane (a road marking line or a road boundary) or the like as the relative position of the host vehicle M with respect to the traveling lane. The recognizer 110 may recognize a position or a posture of another vehicle traveling in the traveling lane of the host vehicle M or recognize whether another vehicle is located on the center side or on the marking line side of the traveling lane when seen from the host vehicle M.

The driving state detector 120 detects a predetermined driving state of an occupant (a driver) of the host vehicle M. The predetermined driving state is, for example, a careless driving state. Careless driving is a state in which a driving operation of the host vehicle M slacks (or is not performed) due to a decrease in attention of a driver or the like. For example, when a state in which an amount of steering operation of the steering wheel 82 by the driver is less than a threshold value (a determination threshold value TH1 which will be described later) is maintained for a predetermined time or more on the basis of the result of detection from the SW sensor 82A, the driving state detector 120 detects a careless driving state of the driver. When a state in which a change in opening level of the accelerator pedal 84 and the brake pedal 86 is less than a threshold value is maintained for a predetermined time or more on the basis of the result of detection from the AP sensor 84A and the BP sensor 86A, the driving state detector 120 may detect the careless driving state of the driver. The predetermined time may be set to be variable, for example, according to the speed of the host vehicle M or a degree of margin to collision between the host vehicle M and an obstacle (for example, another vehicle). Accordingly, it is possible to perform more appropriate careless driving determination on the basis of the speed of the host vehicle M and the positional relationship between the host vehicle M and the obstacle. The predetermined time may be a fixed time.

When it is determined that a driver's state detected on the basis of an analysis result of an image captured by the driver monitoring camera 70 is not a state appropriate for driving, the driving state detector 120 may detect that the driver's state is a careless driving state. A case in which the driver's state is not a state appropriate for driving is, for example, a case in which the driver does not monitor the surroundings (particularly, a forward view) of the host vehicle M by a side glance or a case in which the driver's concentration is predicted to decrease due to a face expression (a drowsy face or a painful face).

The driving state detector 120 may detect details of the driver's driving operation. For example, the driving state detector 120 may detect an amount of steering of the driver (an amount of torque of a steering torque) based on the detection result from the SW sensor 82A, detect an operation (an opening level) of the accelerator pedal 84 based on the detection result from the AP sensor 84A, or detect an operation (an opening level) of the brake pedal 86 based on the BP sensor 86A. The driving state detector 120 may detect a state in which the driver does not perform a driving operation.

The collision possibility determiner 130 recognizes whether there is a possibility of collision between an obstacle (for example, another vehicle) and the host vehicle M on the basis of the surrounding situation (outside information) recognized by the recognizer 110. For example, the collision possibility determiner 130 determines whether there is a possibility of collision between the host vehicle M and another vehicle on the basis of a collision margin value with another vehicle (preceding vehicle) present in front of the host vehicle M based on the surrounding situation. The collision margin value is, for example, a value which is set on the basis of a time-to-collision (TTC) or may be a value which is set on the basis of a time headway (THW). The time-to-collision TTC is derived, for example, by dividing a relative distance by a relative speed in a relationship between the host vehicle M and another vehicle. The time headway THW is derived, for example, by dividing a relative distance (an inter-vehicle distance) by the speed of the host vehicle M. For example, the time-to-collision TTC may be derived using a trained model or a predetermined function that outputs the time-to-collision TTC when positions and speeds of the host vehicle M and another vehicle are input thereto or may be derived using a correspondence table in which a relative speed and a relative position are correlated with the time-to-collision TTC. This derivation method is similarly applied to the time headway THW. For example, as the time-to-collision TTC (the time headway THW) becomes shorter, the collision margin value becomes smaller (that is, as the time-to-collision becomes longer, the collision margin value becomes larger). For example, the collision possibility determiner 130 determines that there is a possibility of collision between the host vehicle M and another vehicle when the collision margin value is less than a threshold value and determines there is no possibility of collision when the collision margin value is equal to or greater than the threshold value.

The controller 140 controls one or both of steering and acceleration/deceleration of the host vehicle M on the basis of at least one of the recognition result from the recognizer 110, the detection result from the driving state detector 120, and the determination result from the collision possibility determiner 130. The controller 140 includes, for example, a braking controller 142 and a steering controller 144.

When it is determined that an obstacle is present in front of the host vehicle M on the basis of the recognition result from the recognizer 110, the braking controller 142 performs at least deceleration control for the host vehicle M on the basis of a target deceleration of the host vehicle M. The braking controller 142 performs braking control for the host vehicle M according to a driving operation of a driver of the host vehicle M (hereinafter referred to as a driver operation) or regardless of the operation. For example, the braking controller 142 sets a deceleration state on the basis of the collision margin value between the host vehicle M and the obstacle and performs deceleration control based on the set deceleration state. The braking controller 142 includes, for example, a slow deceleration controller 142A and a collision avoidance braking controller 142B.

When the recognizer 110 determines that an obstacle (for example, another vehicle) is present in front of the host vehicle M, the slow deceleration controller 142A performs slow deceleration control for the host vehicle M. Slow deceleration control is control (attention attraction control) for attracting the attention of the driver to approach another vehicle using vehicle behavior of deceleration and is control which is different from collision avoidance control for avoiding collision with an obstacle (here, collision with an obstacle may be avoided as a result). For example, when it is determined that an obstacle is present in front of the host vehicle M, the slow deceleration controller 142A derives a target deceleration of the host vehicle M and decelerates the host vehicle M regardless of the driver's operation such that the deceleration approaches the derived target deceleration. Slow deceleration control may be performed when the driving state detector 120 detects that the driver performs careless driving or may be performed when the collision margin value satisfies an operating condition of slow deceleration control.

When the driving state detector 120 detects the driver's accelerator operation (an operation on the accelerator pedal 84) equal to or greater than a predetermined value (for example, a predetermined amount) in slow deceleration control, the slow deceleration controller 142A may stop the slow deceleration control. In this way, by determining the driver's intention on the basis of the accelerator operation, it is possible to perform more appropriate override control (for switching to the driver's manual control) with respect to the slow deceleration control. The predetermined value (the predetermined amount) may change on the basis of an operating speed in the driver's accelerator operation. For example, the slow deceleration controller 142A sets the predetermined value to be less when the operating speed is equal to or greater than a predetermined speed than when the operating speed is lower than the predetermined speed and sets the predetermined value to be greater when the operating speed is less than the predetermined speed than when the operating speed is equal to or greater than the predetermined speed. The slow deceleration controller 142A may change the predetermined value according to the target deceleration and set the predetermined value to be greater as the target deceleration becomes greater. Accordingly, it is possible to realize more appropriate override determination according to a driver's driving situation or the surrounding situation of the host vehicle M.

The collision avoidance braking controller 142B performs emergency brake control for avoiding collision between the host vehicle M and an obstacle. For example, when it is determined that there is a possibility of collision between the host vehicle M and an obstacle on the basis of the surrounding situation recognized by the recognizer 110, the collision avoidance braking controller 142B performs braking control (deceleration control) for avoiding collision. Braking control performed by the collision avoidance braking controller 142B includes, for example, collision mitigation brake system (CMBS) control for supporting collision avoidance or damage reduction. Braking control performed by the collision avoidance braking controller 142B may be performed, for example, after slow deceleration control has been performed or may be performed when the collision margin value satisfies an operating condition of the braking control.

The steering controller 144 controls steering of the host vehicle M. The steering controller 144 includes, for example, a centering steering controller 144A and a collision avoidance steering controller 144B. When the recognizer 110 determines that an obstacle is present in front of the host vehicle M, the centering steering controller 144A performs steering control for moving the host vehicle M to the center of the traveling lane (centering steering control). This steering control is not for avoiding collision with an obstacle, but is control for attracting the attention of the driver to the obstacle in front through vehicle behavior of lateral movement to the center side (movement in the road width direction) (here, collision with an obstacle may be avoided as a result). Through this steering control, it is possible to allow the driver to be aware of an obstacle in front early and to contribute to driving for avoiding collision. This centering steering control may be performed when the driving state detector 120 detects that the driver performs careless driving or may be performed when the collision margin value satisfies an operating condition of steering control. The slow deceleration control and the centering steering control may be separately performed or may be simultaneously performed at the same timing (for example, in an attention attraction control step).

The collision avoidance steering controller 144B performs steering control for the host vehicle M for avoiding collision between the host vehicle M and an obstacle. For example, when avoidance in the traveling lane of the host vehicle M is possible, the collision avoidance steering controller 144B performs a steering operation of moving in a direction in which the host vehicle M does not collide with an obstacle without departing from the same lane regardless of the driver's steering operation. The collision avoidance steering controller 144B may perform steering control for the host vehicle M such that the behavior of the host vehicle M after an avoidance operation has been performed is stabilized after the host vehicle M has performed an operation of going over a marking line defining the traveling lane to avoid the obstacle through the driver's steering operation. The steering control performed by the collision avoidance steering controller 144B may be performed, for example, after the centering steering control has bene performed or may be performed when the collision margin value satisfies an operating condition of the steering control.

The controller 140 may perform control other than the aforementioned vehicle control. For example, the controller 140 performs steering control for maintaining the host vehicle M in the traveling lane as lane keeping assistance system (LKAS) control (lane keeping control). In this case, for example, the controller 140 supports the driver's steering operation by controlling the steering device 220 such that the host vehicle M does not depart from the traveling lane.

The HMI controller 150 notifies an occupant (including a driver) of predetermined information through the HMI 30. The predetermined information includes, for example, information associated with traveling of the host vehicle M such as information on the state of the host vehicle M or information on driving control. The information on the state of the host vehicle M includes, for example, a speed, an engine rotation speed, and a shift position of the host vehicle M. The information on driving control includes, for example, a type of driving control under execution (for example, slow deceleration, centering steering control, collision avoidance braking control, or collision avoidance steering control), an operating reason of driving control, a situation of driving control, and information indicating that driving control has started or ended. The information on driving control may include information on attention attraction or alarm for the driver. The predetermined information may include information on a current position or a destination of the host vehicle M and a residual amount of fuel or may include information not associated with traveling control of the host vehicle M such as television programs and content (for example, movies) stored in a storage medium such as DVD.

For example, the HMI controller 150 may generate an image including the predetermined information and display the generated image on the display 32 of the HMI 30 or may generate sound indicating the predetermined information and output the generated sound from the speaker 34 of the HMI 30. The timing at which sound is output is, for example, a timing at which driving control starts or stops, a timing of an incoming call, a timing at which a displayed image is switched, and a timing at which the host vehicle M enters a predetermined state. The HMI controller 150 may output information received by the HMI 30 to the controller 140 or the like. The HMI controller 150 controls an output start timing or an output end timing of information output by the HMI 30 on the basis of control details in the controller 140.

### Controller

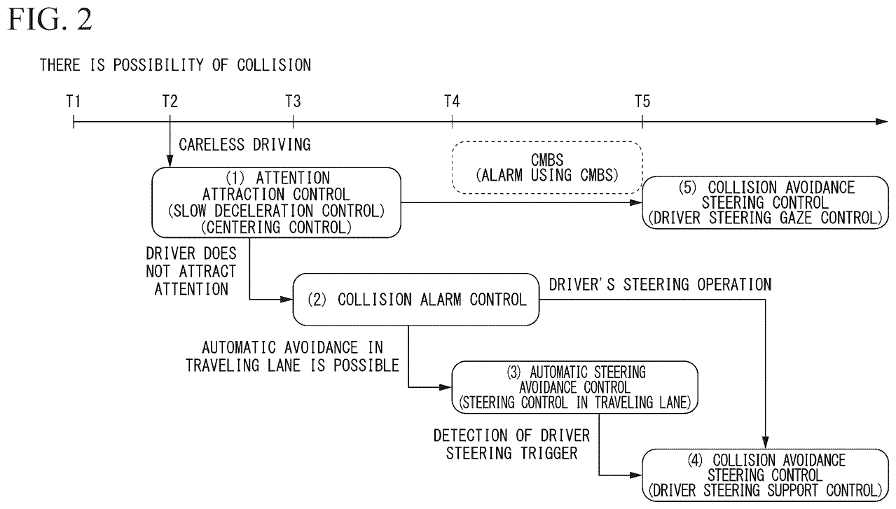

Details of vehicle control that is performed by the controller 140 will be described below. FIG. 2 is a diagram illustrating details of vehicle control associated with collision avoidance. In the example illustrated in FIG. 2, details of vehicle control which is performed when it is determined that there is a possibility of collision on the basis of the time-to-collision TTC are illustrated. In the example illustrated in FIG. 2, it is assumed that time T1 is the earliest and times T2, T3, T4, and T5 are later in this order.

First, at time T1 in FIG. 2, it is assumed that the collision possibility determiner 130 determines that there is a possibility of collision between the host vehicle M and an obstacle. When it is determined that there is a possibility of collision, the controller 140 performs attention attraction control ((1) in the drawing) for attracting the attention of a driver to the surroundings (particularly, the traveling direction) on the basis of the time-to-collision TTC and the detection result from the driving state detector 120. Attention attraction control and collision alarm control which will be described later are, for example, control which is performed before control for avoiding collision between the host vehicle M and an obstacle (for example, another vehicle) is performed.

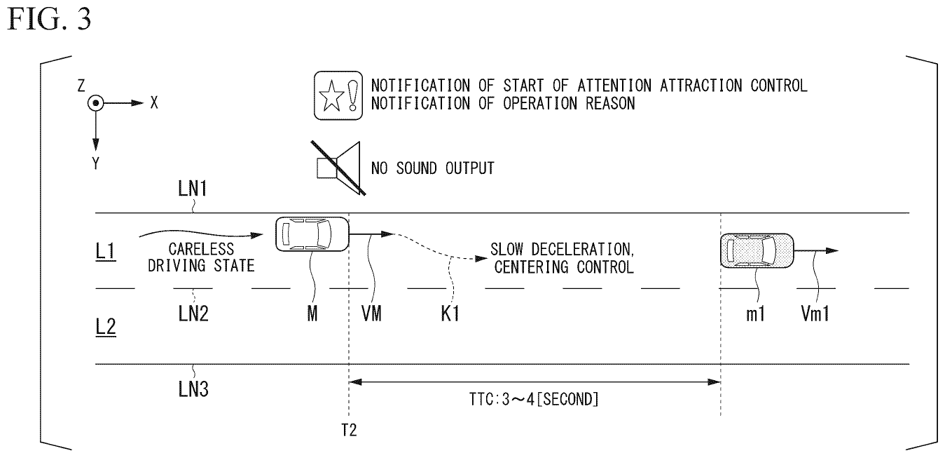

FIG. 3 is a diagram illustrating details of attention attraction control. In the example illustrated in FIG. 3, lanes L1 and L2 extending in the same direction (the X-axis direction in the drawing) are illustrated. The lane L1 is defined by marking lines LN1 and LN2, and the lane L2 is defined by marking lines LN2 and LN3. In the example illustrated in FIG. 3, it is assumed that the host vehicle M is traveling at a speed VM in the lane L1 and a vehicle (a preceding vehicle) m1 traveling in front of the host vehicle M is traveling at a speed Vm1 in the lane L1 in front of the host vehicle M. In the following description, it is assumed that the other vehicle m1 is an obstacle.

In the example illustrated in FIG. 3, the controller 140 performs attention attraction control when it is determined that the driver is performing careless driving at time T2 at which the time-to-collision TTC (collision margin value) based on the relative position and the relative speed between the host vehicle M and the other vehicle m1 is equal to or less than a first predetermined value (a predetermined time). Time T2 is, for example, a value which is set with the time-to-collision TTC in a range of about 3 [sec] to 4 [sec], and may be set to be variable on the basis of the relative speed, the relative position, a road shape, or the like.

Attention attraction control includes, for example, at least one of slow deceleration control performed by the slow deceleration controller 142A and centering steering control performed by the centering steering controller 144A. Slow deceleration control which is performed in attention attraction control is control in a first deceleration state. The slow deceleration controller 142A sets a target deceleration (a first target deceleration) such that a load (longitudinal G) of a first deceleration upper limit (about 0.1 [G]) in the traveling direction (the longitudinal direction) is applied to the driver. In attention attraction control (the first deceleration state), the slow deceleration controller 142A may first perform slow deceleration control with a first degree of deceleration (for example, longitudinal G of 0.05 [G]) and then perform deceleration control with a second degree of deceleration (for example, longitudinal G of 0.1 [G]) greater than the first degree of deceleration. By performing control such that the degree of deceleration increases stepwise in this way, it is possible to reduce a burden on an occupant such as a driver at the time of execution start of slow deceleration control and to curb the occupant being startled due to the slow deceleration control.

In attention attraction control, the centering steering controller 144A performs centering steering control for steering the host vehicle M to the center of the traveling lane (the lane L1). Details of centering steering control will be described later. In the example illustrated in FIG. 3, the controller 140 generates a future target trajectory K1 of the host vehicle M corresponding to slow deceleration and centering steering control and controls steering and the speed of the host vehicle M such that the host vehicle M travels along the target trajectory K1.

At time T2, the HMI controller 150 may generate an image notifying the driver that at least one of slow deceleration control and centering steering control in the attention attraction control has started or an image indicating an operation reason thereof and display the generated image on the display 32 to notify the driver (here, no sound is output). Accordingly, it is possible to attract the attention of the driver by notifying the driver of approach to an obstacle and to prompt an occupant to perform an avoidance operation early. When attention attraction control ends, the HMI controller 150 may generate and output an image indicating that the control has ended. When the control has ended, the HMI controller 150 may delete the image indicating the start which is being displayed from the display 32 instead of displaying an image indicating the end.

Here, when operation determination is performed using the time-to-collision TTC and the relative speed between the host vehicle M and another vehicle m1 is 0 (zero), there is a likelihood that attention attraction control is not able to be performed at an appropriate timing. When the other vehicle m1 decelerates or the host vehicle M accelerates, there is a likelihood that the operation timing will be delayed. Accordingly, when slow deceleration control or centering steering control is performed, the controller 140 may estimate a position of the other vehicle m1 before or after a predetermined time and perform operation determination of attention attraction control on the basis of the estimated position.

Referring back to FIG. 2, when it is detected that the driver is performing careless driving at time T3 at which the time-to-collision TTC (collision margin value) becomes less than a predetermined value (a predetermined time) in a state in which the attention of the driver has not been attracted (override control) in spite of the attention attraction control, collision alarm control ((2) in the drawing) is performed. Time T3 is, for example, a time at which the time-to-collision TTC is about 2 [sec].

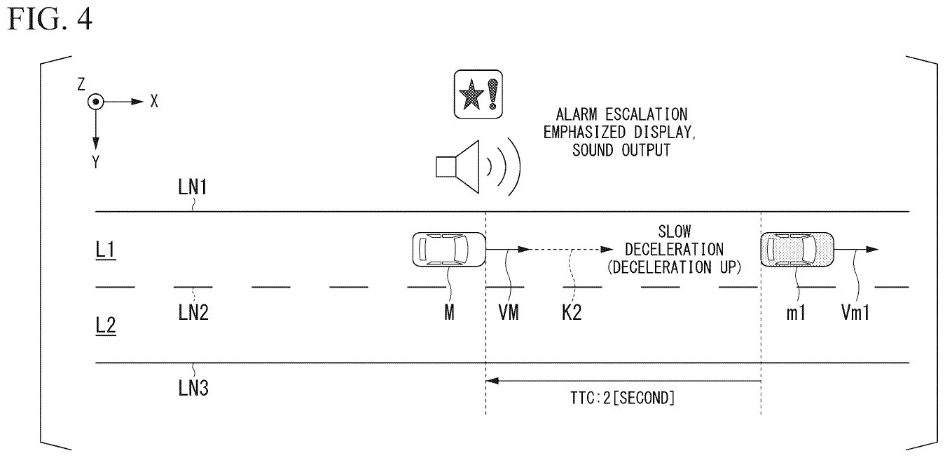

FIG. 4 is a diagram illustrating details of collision alarm control. In FIG. 4, an example in which the time-to-collision TTC is set to 2 [sec] without the driver's accelerator operation in the situation illustrated in FIG. 3 is illustrated. In the collision alarm control step, the slow deceleration controller 142A sets a target deceleration (a second target deceleration) and performs slow deceleration control corresponding to the set second target deceleration. The slow deceleration controller 142A may generate a target trajectory K2 for performing slow deceleration control and perform control such that the host vehicle M travels along the generated target trajectory K2. Slow deceleration control that is performed in the collision alarm control is control in a second deceleration state. In the second deceleration state, the slow deceleration controller 142A sets the target deceleration (the second target deceleration) such that a larger load (longitudinal G) than the first deceleration upper limit is applied to the driver at a second deceleration upper limit (about 0.2 [G]) or less in the traveling direction (the longitudinal direction). Accordingly, it is possible to allow the driver to be more clearly aware that the host vehicle M is approaching the other vehicle m1. By performing deceleration control while increasing the deceleration according to necessity in this way, it is possible to take a long time for becoming aware of the other vehicle m1 and to allow the driver to perform an operation of avoiding collision with the other vehicle m1 with ample time.

Here, when deceleration based on attention attraction control or collision alarm control is performed, the slow deceleration controller 142A may adjust the target deceleration or a position at which deceleration control based on the target deceleration is to end according to whether an accelerator operation of the driver of the host vehicle M is detected on the basis of the detection result from the AP sensor 84A.

In collision alarm control, as described above, centering steering control may be performed by the centering steering controller 144A in addition to (or instead of) slow deceleration control. In collision alarm control, the HMI controller 150 may emphasize and display an image of attention attraction information displayed on the display 32 or perform control (alarm escalation) for outputting an alarm from the speaker 34. Accordingly, by strongly notifying the driver that there is a high likelihood of collision while performing slow deceleration control or centering steering control, it is possible to more clearly attract the attention of the driver to perform a collision avoiding operation. When the collision alarm control ends, the HMI controller 150 may generate and output an image or sound indicating that the collision alarm control ends. When the collision alarm control ends, the HMI controller 150 may end outputting of an image or sound indicating the start instead of outputting the image or sound indicating the end.

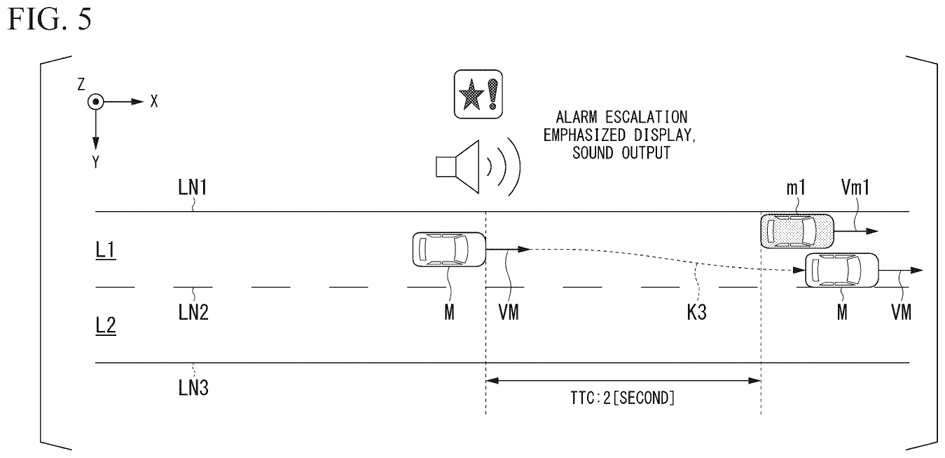

Referring back to FIG. 2, after the collision alarm control has been performed, the steering controller 144 performs automatic steering avoidance control at time T4 at which automatic avoidance in the traveling lane is determined to be possible ((3) in FIG. 2). FIG. 5 is a diagram illustrating details of automatic steering avoidance control. In the example illustrated in FIG. 5, for example, control when the driver has not performed an accelerator operation after collision alarm control has been performed is performed. In this case, when an avoidance space is present in the traveling lane on the basis of an area of the traveling lane and a position of another vehicle m1, the collision avoidance steering controller 144B generates a target trajectory K3 for traveling to the avoidance space and performs steering control (speed control according to necessity) such that the host vehicle M travels according to the generated target trajectory K3. The collision avoidance steering controller 144B may perform acceleration/deceleration control in addition to steering control. In automatic steering avoidance control, the HMI controller 150 may continue to perform the alarm escalation control. Accordingly, when steering avoidance is possible through control with high stability, it is possible to realize more appropriate vehicle control by performing automatic steering control.

At this timing, CMBS control may be performed in parallel by the collision avoidance braking controller 142B. When CMBS control is performed, the aforementioned automatic steering avoidance control or collision avoidance steering control which will be described later may not be performed.

Referring back to FIG. 2, at time T5 at which the driver operates the steering wheel 82 (a driver steering trigger is detected) to perform a steering operation in a direction in which another vehicle m1 is avoided, the collision avoidance steering controller 144B performs collision avoidance steering control such that the host vehicle M does not depart from the neighboring lane (lane L2) adjacent to the traveling lane (lane L1) ((4) in FIG. 2). The collision avoidance steering control may be performed after the automatic steering avoidance control has been performed or may be performed after the collision alarm control has been performed.

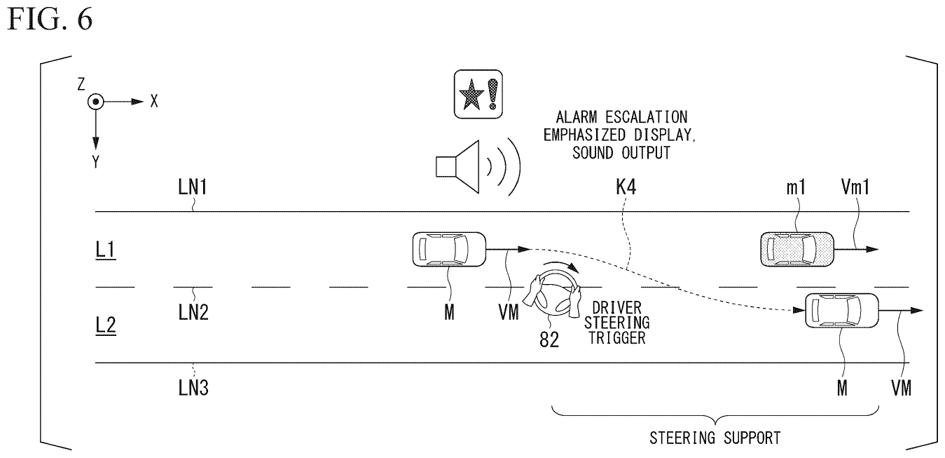

FIG. 6 is a diagram illustrating steering control after a driver steering trigger has been detected. In the example illustrated in FIG. 6, when a space for avoiding collision between the host vehicle M and another vehicle m1 is not present in the lane L1 and a driver steering trigger (an amount of steering of the steering wheel 82 by the driver equal to or greater than a threshold value) is detected, the collision avoidance steering controller 144B performs steering control of the host vehicle M such that the host vehicle M is allowed to move from the lane L1 to the neighboring lane L2 and does not depart from the neighboring lane L2. For example, the collision avoidance steering controller 144B generates a target trajectory K4 for changing to the lane L2 and performs steering support such that the position of the host vehicle M approaches the target trajectory K4 through the driver's steering operation. In the collision avoidance steering control, the HMI controller 150 may continue to perform the alarm escalation control. Accordingly, it is possible to realize more appropriate vehicle control after emergency avoidance steering has been performed through the driver's steering operation.

When the time-to-collision TTC approaches a limit value immediately after the attention attraction control illustrated in (1) of FIG. 2 has been performed and the driver performs a steering operation, the controller 140 performs collision avoidance steering control (driver steering support control) such that the host vehicle M does not go over the neighboring lane similarly to the control illustrated in (4) of FIG. 2 ((5) in FIG. 2). In this case, the HMI controller 150 may perform notification control for notifying or alarming that steering support operates.

In the situations in which the attention attraction, the collision alarm, the automatic steering avoidance, and the collision avoidance steering operate, a condition associated with the speed of the host vehicle M may be added to the operation determination conditions. For example, in collision avoidance steering control in the automatic steering avoidance or the collision avoidance steering (steering support), a condition in which the speed VM of the host vehicle M is equal to or higher than 40 [km/h] is used as one operation starting condition. Since this control is control after the attention attraction has been performed, collision avoidance in response to the driver's braking operation is possible with only the time-to-collision TTC of about 2 [sec]. Control is performed such that centering steering control in the attention attraction and the collision alarm is performed when the speed VM of the host vehicle M is equal to or higher than 30 [km/h]. Control is performed such that slow deceleration control in the attention attraction and the collision alarm is performed when an accelerator operation (AP operation) is performed and the speed VM of the host vehicle M is equal to or higher than 30 [km/h]. Since this speed is lower than a steering avoidance limit speed and is in a range with a performance margin of CMBS control, it is possible to realize more appropriate driving control by setting this condition. When an AP operation is not performed, the control is performed when the speed VM of the host vehicle M is equal to or higher than 5 [km/h]. That is, the speed is set to be lower when the driver's AP operation is not detected than when the AP operation is detected. Accordingly, by loosening the starting conditions of slow deceleration control in a situation in which the AP operation is not detected, it is possible to perform slow deceleration control in various situations including careless driving in a traffic jam and to more safely avoid collision between the host vehicle M and another vehicle m1.

### Override Control

Control (slow deceleration control, centering steering control) which is being performed in the attention attraction or the collision alarm may be stopped during the control, for example, in response to the driver's predetermined operation of the driving operator 80. For example, when the driver operates the accelerator pedal 84 for accelerating the host vehicle M while performing slow deceleration control and the amount of operation performed on the accelerator pedal is equal to or greater than a first predetermined amount, the slow deceleration controller 142A stops the slow deceleration control. When an accelerator operation speed instead of the amount of operation performed on the accelerator pedal is equal to or higher than a predetermined speed, the slow deceleration controller 142A may stop the slow deceleration control.

When the driver operates the steering wheel 82 while performing centering steering control and the amount of operation performed on the steering wheel (an amount of torque (a steering torque) of the steering wheel 82) is equal to or greater than a second predetermined amount, the centering steering controller 144A stops the centering steering control. The second predetermined amount may be set to be variable according to whether a steering direction of the operation performed by the driver is forward or reverse with respect to steering based on the centering steering control. The forward steering direction is defined when the steering direction of the operation performed by the driver is the same as the steering direction based on the centering steering control, and the reverse direction is defined when the steering direction of the operation performed by the driver is reverse to the steering direction based on the centering steering control. In this way, by performing override determination in consideration of the driver's intention from the steering direction of the steering wheel 82 operated by the driver, it is possible to perform more appropriate override control during the centering steering control.

### Centering Steering Control

Centering steering control in the attention attraction or the collision alarm according to the embodiment will be described below. In the following description, several examples associated with centering steering control will be divisionally described.

### First Example

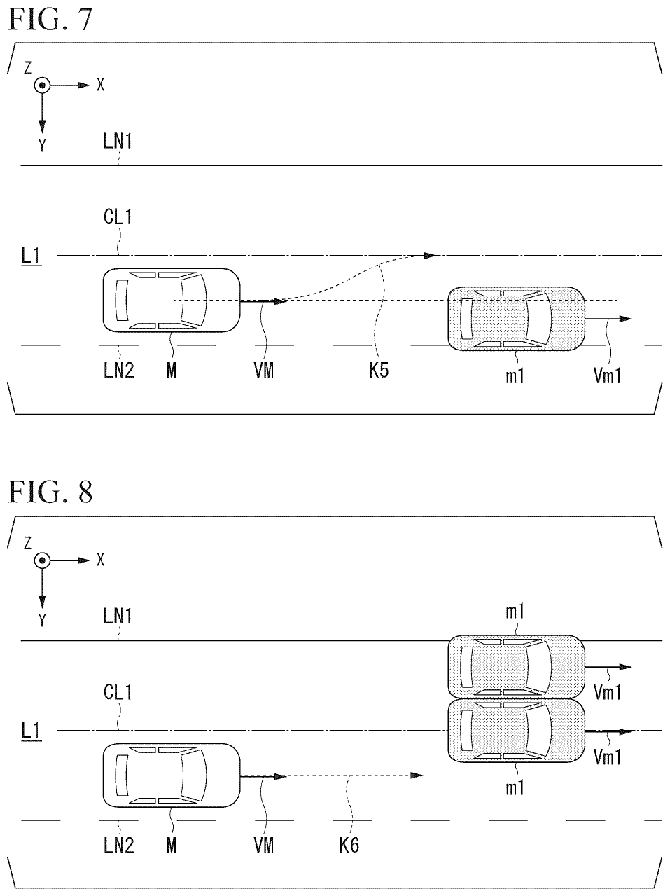

FIG. 7 is a diagram illustrating a first example of centering steering control. In the example illustrated in FIG. 7, the host vehicle M traveling in a lane L1 defined by marking lines LN1 and LN2 and another vehicle m1 which is preceding vehicle are illustrated. For example, when the other vehicle m1 is approached, the centering steering controller 144A generates a target trajectory K5 for moving the host vehicle M to a lane center CL1 and performs steering control such that the host vehicle M travels along the generated target trajectory K5.

By steering the host vehicle M to the lane center CL1 in this way, it is possible to allow the driver to easily be aware of the other vehicle m1 due to change in behavior in the lateral direction (the width direction of the traveling lane) of the host vehicle M when the driver is not aware of the other vehicle m1 in front and to contribute to avoidance of collision between the host vehicle M and the other vehicle m1. Steering control in the attention attraction control is behavior for attracting the attention of the driver to the surroundings and thus is control other than the steering control for causing the host vehicle M to avoid the other vehicle m1. However, in the steering control of the first example, since steering is performed in a direction away from the other vehicle m1 as a result, the driver can easily perform avoidance driving thereafter.

### Second Example

FIG. 8 is a diagram illustrating a second example of centering steering control. In the example illustrated in FIG. 8, a case in which the other vehicle m1 is present in the vicinity of the lane center CL1 or on the opposite side of the host vehicle M with respect to the lane center CL1 when seen from the host vehicle M is summarized. The opposite side is, for example, a farther marking line side out of the marking lines LN1 and LN2 when seen from the host vehicle M. The opposite side is a position in the same lane outside of the lane center CL1 when seen from the host vehicle M. In this case, the centering steering controller 144A does not perform steering control for moving the host vehicle M to the lane center CL1. In this case, the controller 140 may generate a target trajectory K6 for causing the host vehicle to travel along the marking line LN2 closer to the host vehicle M out of two marking lines LN1 and LN2 defining the lane L1 (more specifically, in a state in which the host vehicle is biased to the marking line LN2 more than the center of the lane L1) and perform control such that the host vehicle M travels along the generated target trajectory K6. When the host vehicle travels biased to the marking line LN2 more than the lane center CL1 before the centering steering control is performed, the controller 140 holds (maintains) that traveling. In this case, the controller 140 may perform LKAS control such that the host vehicle M does not depart from the traveling lane. As in the second example, when steering control for moving the host vehicle M to the center of the traveling lane is not performed, the controller 140 may perform deceleration control (for example, slow deceleration control) for the host vehicle M.

### Third Example

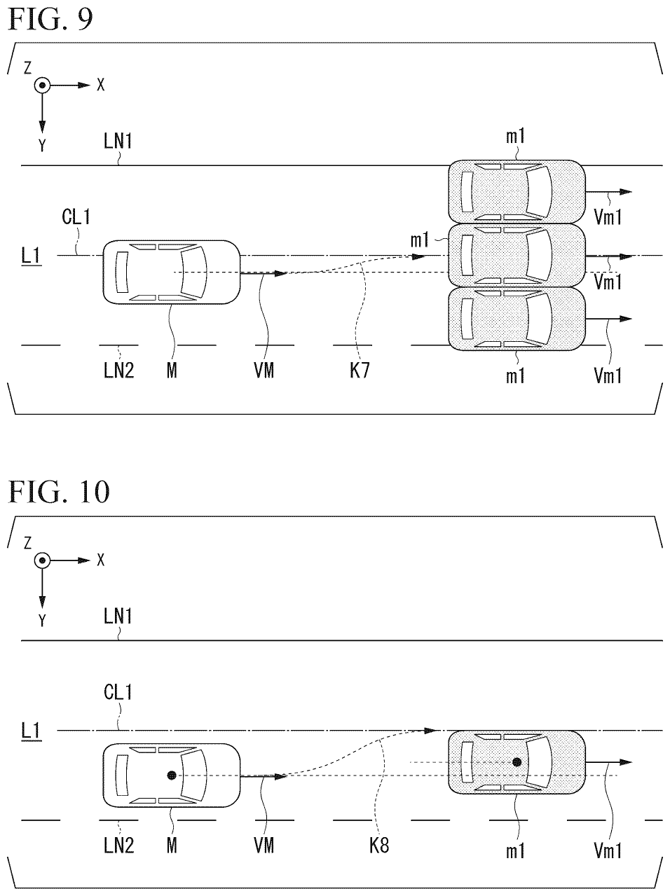

FIG. 9 is a diagram illustrating a third example of centering steering control. As illustrated in FIG. 9, in the third example, when another vehicle m1 is located at any position in the lane L1 (near the lane center or near each marking line defining the lane L1) and the host vehicle M is present in a lane center error range, the centering steering controller 144A generates a target trajectory K7 for moving the host vehicle M to the lane center CL1 and performs steering control such that the host vehicle M travels along the generated target trajectory K7. The lane center error range will be described later. In this way, it is possible to allow the driver to be aware that there is a preceding vehicle through behavior of lateral movement (movement in the road width direction or movement in the Y-axis direction in the drawing) of the host vehicle M.

### Fourth Example

FIG. 10 is a diagram illustrating a fourth example of centering steering control. In the fourth example, when another vehicle m1 is present within a predetermined range from the host vehicle M (a lateral position error range) in a width direction of the traveling lane, steering control is performed such that the host vehicle M moves to the center of the traveling lane. The lateral position error range will be described later. As illustrated in FIG. 10, in the fourth example, when the host vehicle M and the other vehicle m1 are close laterally (within the lateral position error range), the centering steering controller 144A generates a target trajectory K8 for moving the host vehicle M to the lane center CL1 and controls steering of the host vehicle M or the like such that the host vehicle M travels along the generated target trajectory K8.

In the fourth example, by locating the host vehicle M at the lane center CL1, steering is performed such that the host vehicle M approaches the other vehicle m1 as a result, but the steering control in the attention attraction is for prompting the driver to become aware and is different from steering control for avoiding collision with the other vehicle m1. Through this control, since the host vehicle M is located at the center of the lane L1 at a time point at which the driver is caused to be aware of the other vehicle, one of the right and left can be easily selected in manual driving thereafter, and the driver can easily perform a steering operation as well as deceleration.

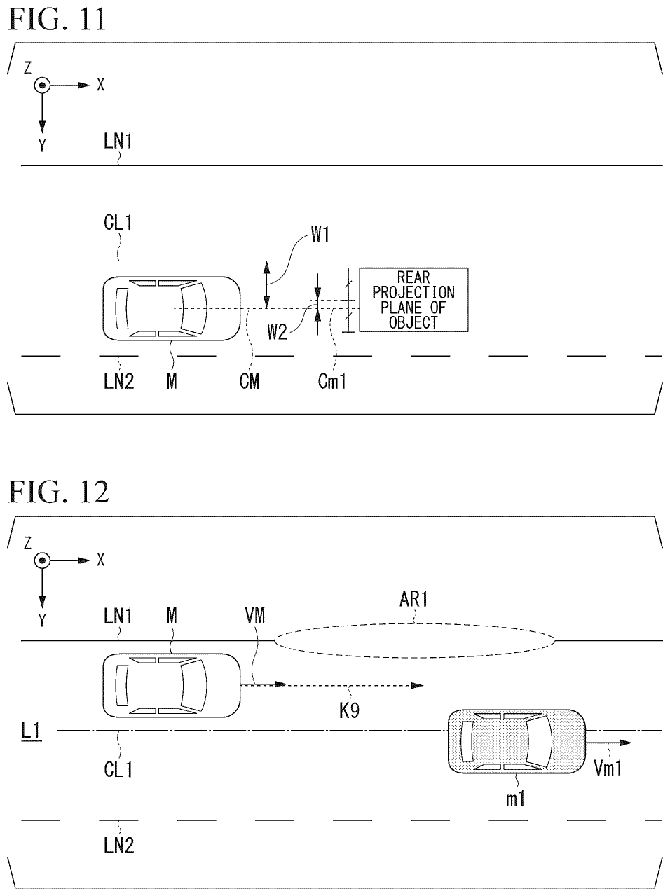

The lane center error range and the lateral position error range will be described below. FIG. 11 is a diagram illustrating the lane center error range and the lateral position error range. In the example illustrated in FIG. 11, a relationship between a rear end projection plane of an object such as another vehicle and a lateral position on a road of the position of the host vehicle M is illustrated. The lane center error range is set to, for example, a range in which a lateral distance W1 between the center (the center of gravity) CM of the host vehicle M and the lane center CL1 is about 0.3 [m] to 0.5 [m] to right and left from the lane center CL1. This is because the host vehicle M is thought to be present substantially near the lane center CL1 in a general lane when the distance W1 is up to 0.5 [m]. However, at 0.5 [m], there is a likelihood that the host vehicle M is biased to any of the marking lines LN1 and LN2. Accordingly, when the distance W1 is less than about 0.3 [m], it is determined that the host vehicle M is present in the lane center error range.

Regarding the lateral position error range between the center CM of the host vehicle M and the center Cm1 of an object, the host vehicle M and the object are determined to be within the lateral position error range when a lateral distance W2 between the center CM and the center Cm1 ranges from 0.2 [m] to 0.3 [m]. Here, in the steering control, behavior of the host vehicle M may stagger in a range of ±0.2 [m], and outside recognition accuracy has an error. Accordingly, when the lateral distance between the host vehicle M and the object is about 0.2 [m], it is considered that there is an area which cannot be used for determination, and it is determined whether the host vehicle M is in the lateral position error range with 0.2 [m] as a lower limit. When this value increases, there is a likelihood that control will also be performed on an object which does not require centering steering control, and thus it is possible to perform more appropriate determination by setting the upper limit to 0.3 [m].

### Fifth Example

FIG. 12 is a diagram illustrating a fifth example of centering steering control. In the fifth example, details of centering steering control based on recognition accuracy of the traveling lane of the host vehicle M are described. In the example illustrated in FIG. 12, the host vehicle M travels at a speed VM in the lane L1 and another vehicle m1 travels at a speed Vm1 in front of the host vehicle M in the same lane as the host vehicle M. In the example illustrated in FIG. 12, the host vehicle M travels biased to the marking line LN1 more than the lane center CL1 out of the marking lines LN1 and LN2 defining the lane L1. In the example illustrated in FIG. 12, it is assumed that it is difficult to recognize a marking line drawn in a partial area AR1 of the marking line LN1 from a camera image due to scratch, loss, or the like.

In the fifth example, the recognizer 110 recognizes the surrounding situation of the host vehicle M. Specifically, the host vehicle M recognizes a position or a speed of the other vehicle m1, positions of the marking lines LN1 and LN2, the lane L1 defined by the marking lines LN1 and LN2, or the like. The recognizer 110 derives degrees of recognition of the marking lines LN1 and LN2. It is assumed that the degree of recognition of the marking line LN1 in the area AR1 is less than a threshold value.

In the fifth example, when the recognizer 110 recognizes that another vehicle m1 is present in front of the host vehicle M and conditions for performing the attention attraction control are satisfied, the controller 140 performs centering steering control for moving the host vehicle M to the center of the traveling lane (may also perform slow deceleration control). Here, when a degree of recognition of at least one of the marking lines LN1 and LN2 by the recognizer 110 is less than a threshold value at the time of performing of centering steering control, the controller 140 (the centering steering controller 144A) stops the centering steering control. Here, “stop” means, for example, that lateral movement is not started before the lateral movement of the host vehicle M based on steering control is started and the lateral movement is stopped when the lateral movement is started.

When the degree of recognition of the marking line LN1 decreases (becomes less than the threshold value), the lane center CL1 cannot be identified, and thus it is possible to perform more appropriate vehicle control according to the surrounding situation of the host vehicle M by ending the centering steering control.

Since the host vehicle M in centering steering control has a smaller amount of lateral movement (an amount of movement in the road width direction or in the Y-axis direction in the drawing) than that in lane change, driving control based on centering steering control is not affected when a state in which the degree of recognition of the marking line is less than the threshold value is maintained for a short time. Accordingly, the controller 140 (the centering steering controller 144A) may stop the centering steering control when the state in which the degree of recognition is less than the threshold value is maintained for a predetermined time or longer.

When both of centering steering control and slow deceleration control are performed as attention attraction control and the degree of recognition is less than the threshold value (that is, when centering steering control is stopped due to a decrease in recognition accuracy), the controller 140 may continue to perform slow deceleration control. Since the slow deceleration control is change in behavior in the longitudinal direction (the front-rear direction) of the host vehicle M, an influence of the decrease in recognition accuracy is smaller than that in the centering steering control in which lateral movement is performed. Accordingly, even when the recognition accuracy of a marking line decreases, it is possible to perform slow deceleration control. Accordingly, since the driver can easily be aware of an obstacle in front, it is possible to curb collision with the front obstacle.

In the fifth example, when the recognition accuracy of a marking line decreases during centering steering control (lateral movement) of the host vehicle M along the target trajectory, the centering steering controller 144A may adjust control details according to the situation of the host vehicle M. For example, the centering steering controller 144A continues to perform the centering steering control when an amount of lateral movement of the other set in the target trajectory is less than a predetermined amount at a timing at which the recognition accuracy of a marking line decreases and stops steering control in the middle way when the amount of lateral movement is equal to or greater than the predetermined amount. For example, the centering steering controller 144A continues to perform the centering steering control when a steering angle of the host vehicle M detected by the vehicle sensor 40 is equal to or greater than a threshold value and stops steering control in the middle way when the steering angle is less than the threshold value. Accordingly, it is possible to perform more appropriate driving control according to the situation of the host vehicle M.

### Sixth Example

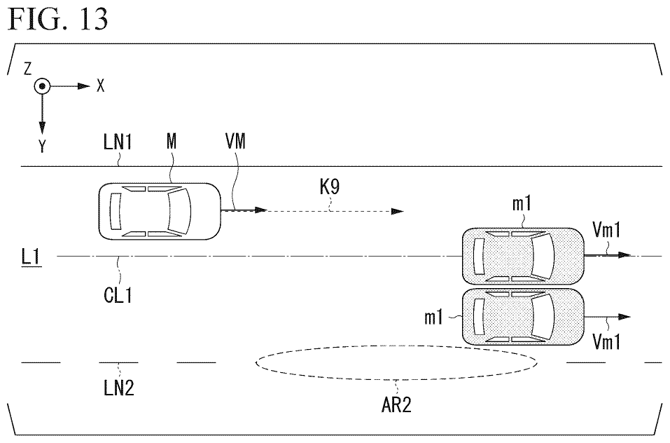

FIG. 13 is a diagram illustrating a sixth example of centering steering control. In the sixth example, it is assumed that it is more difficult to recognize a marking line drawn in a partial area AR2 of the marking line LN2 out of the marking lines LN1 and LN2 from a camera image due to scratch, loss, or the like in comparison with the fifth example. In the example illustrated in FIG. 13, a situation in which another vehicle m1 is present at the lane center CL1 or on the opposite side is summarized.

In the sixth example, for example, when the degree of recognition of the marking line LN1 closer to the host vehicle M out of two marking lines LN1 and LN2 defining the lane L1 is equal to or greater than a threshold value and the degree of recognition of the marking line LN2 farther from the host vehicle M is less than threshold value, the controller 140 causes the host vehicle M to travel along the marking line LN1. For example, when another vehicle m1 is present on the center side of the lane L1 or on the opposite side thereof, the controller 140 generates a target trajectory K9 along which the host vehicle M travels biased to the marking line closer to the host vehicle M (the marking line LN1 in FIG. 13) and performs control such that the host vehicle travels along the generated target trajectory K9 as described above in the second example. When the host vehicle M travels biased to the marking line LN1 more than the lane center CL1 before the centering steering control is performed, the controller 140 holds (maintains) that traveling. In this case, the controller 140 may perform LKAS control such that the host vehicle M does not depart from the traveling lane. As in the sixth example, when steering control for moving the host vehicle M to the center of the traveling lane is not performed, the controller 140 may perform deceleration control (for example, slow deceleration control) for the host vehicle M.

Accordingly, when the recognition accuracy of the marking line closer to the host vehicle M out of the marking lines defining the traveling lane L1 of the host vehicle M is not low (the degree of recognition is equal to or greater than a threshold value), it is possible to continue to perform driving control along the marking line even if the recognition accuracy of the farther marking line is low (the degree of recognition is less than the threshold value). As illustrated in FIG. 12, when the recognition accuracy of the marking line LN1 closer to the host vehicle M is low, the centering steering control is stopped even if the recognition accuracy of the farther marking line LN2 is not low. Accordingly, it is possible to curb performing of larger lateral movement than that in the centering steering for bias to the farther marking line LN2.

For example, when at least one of centering steering control and slow deceleration steering control is started by the controller 140, the HMI controller 150 outputs information (such as an image) indicating that the control starts from the HMI 30. When the control under execution is ended, the HMI controller 150 outputs information indicating that the control under execution ends from the HMI 30. As described above in the fifth example, when the degrees of recognition of the marking lines LN1 and LN2 defining the traveling lane L1 of the host vehicle M by the recognizer 110 become less than the threshold value at the time of performing of centering steering control, the centering steering control is stopped, and slow deceleration control continues to be performed, the HMI controller 150 may not notify that the centering steering control ends. Accordingly, it is possible to curb the driver being confused because the driver is notified of the end when the slow deceleration control is continuously performed but the steering control is ended. The driver can concentrate attention to avoidance of an obstacle in front without paying attention to the notification of the end.

### Process Flow

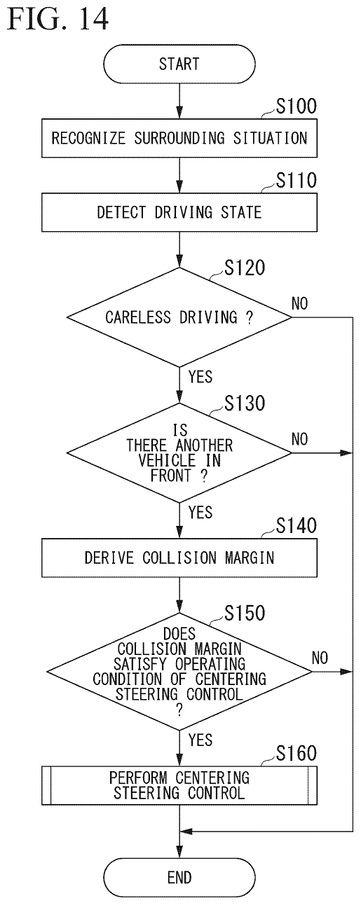

FIG. 14 is a flowchart illustrating an example of a process flow that is performed by the driving support device 100 according to the embodiment. In the example illustrated in FIG. 14, processes associated with centering steering control out of processes performed by the driving support device 100 will be mainly described. The following process flow may be performed repeatedly at intervals of a predetermined period or at predetermined timings.

In the example illustrated in FIG. 14, the recognizer 110 recognizes a surrounding situation of a host vehicle M (Step S100). Then, the driving state detector 120 detects a driving state of an occupant (a driver) of the host vehicle M (Step S110). Then, the driving state detector 120 determines whether the driving state of the driver is careless driving (Step S120). When it is determined that the driving state is careless driving, the collision possibility determiner 130 determines whether another vehicle m1 (an example of an obstacle) is present in front of the host vehicle M (Step S330). When it is determined that another vehicle m1 is present in front, the collision possibility determiner 130 derives a collision margin value between the host vehicle M and the other vehicle m1 (Step S140).

Then, the controller 140 determines whether the collision margin value satisfies the operating condition of centering steering control (that is, an execution condition of attention attraction control) (Step S150). When it is determined that the operating condition is satisfied, the controller 140 performs a centering steering control process (Step S160). Details of the process of Step S160 will be described later. In this way, this routine of the flowchart ends. When it is determined in Step S120 that the driving state is not careless driving, it is determined in Step S130 that another vehicle is not present in front, and it is determined in Step S150 that the collision margin value does not satisfy the operating condition of the centering steering control, this routine of the flowchart ends. In the embodiment, in addition to (instead of) the processes of Steps S150 and S160, the controller 140 may determine whether the collision margin value satisfies an operating condition of slow deceleration control and perform slow deceleration control when it is determined that the operating condition of slow deceleration control is satisfied.

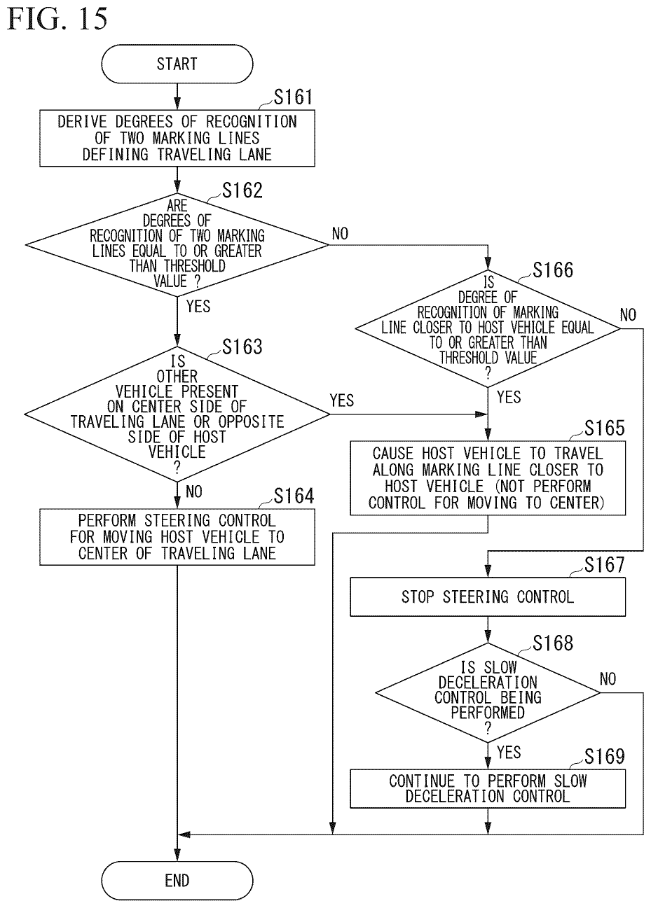

FIG. 15 is a flowchart illustrating an example of the centering steering control process. The process flow illustrated in FIG. 15 corresponds to the process of Step S160. In the example illustrated in FIG. 15, the controller 140 derives degrees of recognition of two marking lines defining the traveling lane of the host vehicle M (Step S161) and determines whether the derived degrees of recognition of two marking lines are equal to or greater than the threshold value (Step S162). When it is determined that the degrees of recognition of two marking lines are equal to or greater than the threshold value, the controller 140 determines whether another vehicle m1 is present on the center side of the traveling lane or the opposite side with respect to the host vehicle M (Step S163). When it is determined that another vehicle m1 is not present on the center side of the traveling lane or the opposite side with respect to the host vehicle M, the controller 140 performs steering control for moving the host vehicle M to the center of the traveling lane (Step S164).

When it is determined in Step S163 that another vehicle m1 is present on the center side of the traveling lane or the opposite side with respect to the host vehicle M, the controller 140 performs control for causing the host vehicle M to travel along the marking line closer to the host vehicle M (Step S165). In this case, the controller 140 does not perform the control for moving the host vehicle M to the lane center.

When it is determined in Step S162 that the degrees of recognition of two marking lines are not equal to or greater than the threshold value (less than the threshold value), the controller 140 determines whether the degree of recognition of the marking line closer to the host vehicle M is equal to or greater than the threshold value (Step S166). When the degree of recognition is equal to or greater than the threshold value, the controller 140 performs the process of Step S165. When it is determined in Step S166 that the degree of recognition is not equal to or greater than the threshold value, the controller 140 stops the steering control (Step S167). Then, the controller 140 determines whether slow deceleration control is being performed (Step S168). When it is determined that slow deceleration control is being performed, the controller 140 continues to perform slow deceleration control until a condition for ending slow deceleration control is satisfied (Step S169). In this way, this routine of the flowchart ends. When it is determined in Step S166 that slow deceleration control is not being performed, this routine of the flowchart ends.

### Modified Examples

In attention attraction control according to the embodiment, the controller 140 may selectively perform one of slow deceleration control and centering steering control, for example, according to road conditions, a position of a nearby vehicle, or the number of nearby vehicles. For example, slow deceleration control and centering steering control may be performed when it is determined that the driver is performing careless driving, and one of slow deceleration and centering steering control may be performed when it is determined that the driver is not performing careless driving. Accordingly, it is possible to perform more appropriate vehicle control according to a driver state.

In the embodiment, slow deceleration control or centering steering control may be performed without determining whether the driver is performing careless driving. The numerical values described in the embodiment are only examples and may be appropriately adjusted according to road conditions (a shape, the number of lanes, and a road type), a driving situation (a degree of carelessness) of the driver, a vehicle situation (a speed, a vehicle model, a shape, and the number of passengers), or the like.

In the embodiment, when there is an area with low recognition accuracy in a marking line in the camera image, the controller 140 may interpolate a marking line of the area using map information. In this case, the controller 140 determines whether the marking line of the area (an area in the vicinity of the area with low recognition accuracy) recognized from the camera image matches the marking line recognized from the map information and performs interpolation only when the marking lines match (a degree of separation between the marking lines is less than a threshold value or a matching ratio is equal to or greater than a threshold value). Accordingly, even when there is an area with low recognition accuracy in the marking line, it is possible to curb stop of centering steering control by interpolating the marking line using the map information.

As described above, the driving support device 100 (an example of the vehicle control device) according to the embodiment includes the recognizer 110 configured to recognize a surrounding situation of a host vehicle M and the controller 140 configured to control one or both of steering and acceleration/deceleration of the host vehicle M when an obstacle is present in front of the host vehicle M on the basis of a recognition result from the recognizer 110. The controller 140 performs at least steering control for moving the host vehicle M to the center of a traveling lane when it is determined that an obstacle is present in front of the host vehicle M. The controller 140 stops the steering control when a degree of recognition of marking lines defining the traveling lane of the host vehicle by the recognizer 110 is less than a threshold value at the time of performing of the steering control. Accordingly, before collision avoidance control between the vehicle and the obstacle is performed, it is possible to perform more appropriate vehicle control according to the surrounding situation of the vehicle.

According to the embodiment, by performing steering to the lane center when an obstacle in front is approached, it is possible to allow a driver to easily be aware of the obstacle in front when the driver is not aware of the obstacle in front and to contribute to avoidance of the obstacle in front. According to the embodiment, it is possible to more appropriately determine whether to stop centering steering control on the basis of recognition accuracy of marking lines defining the traveling lane. According to the embodiment, even when the recognition accuracy of the marking line farther from the host vehicle M out of two marking lines defining the traveling lane decreases (when a degree of recognition is less than a threshold value) and the recognition accuracy of the marking line closer to the host vehicle M is not low (when a degree of recognition is equal to or greater than the threshold value), it is possible to improve continuity of steering control by continuing steering control for causing the host vehicle to travel along the marking line without performing steering to the lane center.

According to the embodiment, when deceleration control along with steering control for moving the host vehicle M to the lane center is being performed, deceleration control continues to be performed even if the recognition accuracy of the marking line decreases, and thus it is possible to allow the driver to easily be aware of an obstacle in front even when the driver is not aware of the obstacle in front. According to the embodiment, when steering control is stopped due to a decrease in recognition accuracy of the marking line and deceleration control continues to be performed, it is possible to curb an occupant being confused due to notification by not notifying that steering control is stopped and to cause the driver to concentrate attention to avoidance of an obstacle in front without paying attention to the notification or the like.

The above-mentioned embodiment can be expressed as follows:
A vehicle control device comprising:
a storage medium configured to store computer-readable instructions; and
a processor connected to the storage medium,
wherein the processor executes the computer-readable instructions to perform:
   recognizing a surrounding situation of a host vehicle; and
   performing driving control for controlling one or both of steering and acceleration/deceleration of the host vehicle when an obstacle is present in front of the host vehicle on the basis of a recognition result,
wherein the driving control includes performing at least steering control for moving the host vehicle to the center of a traveling lane when it is determined that an obstacle is present in front of the host vehicle, and
wherein the driving control includes stopping the steering control when a degree of recognition of marking lines defining the traveling lane of the host vehicle by the recognizer is less than a threshold value at the time of performing of the steering control.

While an embodiment of the present invention has been described above, the present invention is not limited to the embodiment and can be subjected to various modifications and substitutions without departing from the gist of the present invention.

What is claimed is:

1. A vehicle control device comprising:
a recognizer configured to recognize a surrounding situation of a host vehicle; and
a controller configured to control one or both of steering and acceleration/deceleration of the host vehicle when an obstacle is present in front of the host vehicle on the basis of a recognition result from the recognizer,
wherein the controller performs at least steering control for moving the host vehicle to the center of a traveling lane when it is determined that an obstacle is present in front of the host vehicle, and
wherein the controller stops the steering control when a degree of recognition of marking lines defining the traveling lane of the host vehicle by the recognizer is less than a threshold value at the time of performing of the steering control.

2. The vehicle control device according to claim 1, wherein the controller causes the host vehicle to travel along a marking line closer to the host vehicle when a degree of recognition of the marking line closer to the host vehicle out of two marking lines defining the traveling lane is equal to or greater than a threshold value and a degree of recognition of a marking line farther from the host vehicle is less than the threshold value.

3. The vehicle control device according to claim 1, wherein the controller performs deceleration control for decelerating the host vehicle when an obstacle is present in front of the host vehicle, and
wherein the controller continues to perform the deceleration control when the degree of recognition of the marking lines defining the traveling lane of the host vehicle by the recognizer is less than the threshold value at the time of performing of the deceleration control.

4. The vehicle control device according to claim 3, further comprising a notification controller configured to notify that at least one control of the steering control and the deceleration control has ended when the control has been ended by the controller,
wherein the notification controller does not notify that the steering control has ended when the degree of recognition of the marking lines defining the traveling lane of the host vehicle by the recognizer becomes less than the threshold value at the time of performing of the steering control and thus the steering control stops but the deceleration control continues to be performed.

5. The vehicle control device according to claim 1, wherein the controller stops the steering control when a state in which the degree of recognition is less than the threshold value is maintained for a predetermined time or more.

6. A vehicle control method that is performed by a computer, the vehicle control method comprising:
recognizing a surrounding situation of a host vehicle; and
performing driving control for controlling one or both of steering and acceleration/deceleration of the host vehicle when an obstacle is present in front of the host vehicle on the basis of a recognition result,
wherein the driving control includes performing at least steering control for moving the host vehicle to the center of a traveling lane when it is determined that an obstacle is present in front of the host vehicle, and
wherein the driving control includes stopping the steering control when a degree of recognition of marking lines defining the traveling lane of the host vehicle is less than a threshold value at the time of performing of the steering control.

7. A non-transitory computer-readable storage medium storing a program, the program causing a computer to perform:
recognizing a surrounding situation of a host vehicle; and
performing driving control for controlling one or both of steering and acceleration/deceleration of the host vehicle when an obstacle is present in front of the host vehicle on the basis of a recognition result,
wherein the driving control includes performing at least steering control for moving the host vehicle to the center of a traveling lane when it is determined that an obstacle is present in front of the host vehicle, and
wherein the driving control includes stopping the steering control when a degree of recognition of marking lines defining the traveling lane of the host vehicle is less than a threshold value at the time of performing of the steering control.
